(19) United States
(12) Patent Application Publication
(10) Pub. No.: US 2009/0045301 A1
(43) Pub. Date: Feb. 19, 2009

(54) Rail mount for flexible conduit

(75) Inventor: John D. Collins, Sturgeon Bay, WI (US)

Correspondence Address: RYAN KROMHOLZ & MANION, S.C., POST OFFICE BOX 26618, MILWAUKEE, WI, 53226, US

(73) Assignee: C&S Manufacturing Corporation

(21) Appl. No.: 11/891,810

(22) Filed: Aug. 13, 2007

(51) Int. Cl. F16L 3/02

(52) U.S. Cl. 248/74.1; 248/65

(57) ABSTRACT

A rail mount having a mounting plate and bracket for supporting a flexible conduit, such as plastic or metal tubing. The mounting plate includes upturned, laterally spaced ear portions, each including an aperture for receiving a supporting rail or rails, the rail or rails being suspended between parallel rigid beams, such as floor joists or wall studs.

### BACKGROUND OF THE INVENTION

The present invention relates generally to mounting brackets for flexible conduits, and, more particularly, to such brackets configured for use in mounting flexible conduits to fixed panels, between wall studs, under flooring for supplying radiant heat to homes or other living or office structures. Specifically, the invention relates to an improved mounting plate for support of such brackets.

For the past several years there has been an increased use of flexible tubing, commonly known as PEX (cross-linked polyethylene) tubing, which is to be used by plumbers in running water lines, versus a long-used copper tubing product.

Prior to the advent of a clamping structure disclosed in Collins U.S. Pat. No. 6,352,224 (the '224 patent) which is owned by the same Assignee as the present invention, the prior commercial clamping structures suffered from the disadvantage of the flexibility of the conduit itself and the manufacturing tolerances between the conduit position and the position and dimensional spacing of supporting structures.

Installation of the tubing required significant manipulation of the conduit with respect to the bracket, and in particular, wherein the tubular conduit required a close bend, such as a 90° bend or a U-bend. This was often the case during sinuous installation of tubing used in radiant heating as the tubing was mounted and stretched end-to-end, or floor-to-ceiling of a room or other area.

The prior '224 patent is directed to a stationary support member providing a protruding bracket configured with an arcuate surface having a relatively close bend for supporting flexible tubular conduit, and to rigidly mount the conduit on a support structure, such as a flat sheet metal mounting plate arranged for direct attachment to a supporting surface.

### SUMMARY OF THE INVENTION

An object of the present invention is to provide a new, simple and efficient mounting plate and bracket for a stationary support member and for securing and adjustably mounting flexible tubular members to supporting structures.

A further, important object of the invention is to provide brackets for supporting the aforementioned tubular members directly to a flat sheet metal mounting plate having means for adjustable attachment to at least one rail member extending across the vertical bracing existing between laterally spaced supporting members, such as vertical studs or horizontally positioned floor joists (parallel beams). A still further object of this invention is to provide brackets of such character that tubular conduit members can be facilely secured thereto with relative ease, but which may be maintained in place following installation thereof.

In accordance with the initial presentation disclosed in the previous-mentioned '224 patent, and in the concept disclosed herein, the present invention, in its preferred embodiment, may be applied to brackets made of a suitable stamped metallic material and, of a construction which defines a substantially elongated, arcuate, continuous channel for supporting the flexible conduit. The channel remains open for substantially its entire length and includes an intermediate portion, a proximal end portion and a distal end portion, each portion being defined by first and second continuous sidewall members for sidewise support of the conduit. The sidewalls each define a conforming margin configured to follow the arcuate contour of the channel. The undulating, open-ended, marginal contour permits curvilinear, sidewise insertion into the open-sided bracket and retention by the arcuate contour thereof.

The improved adjustable mounting plate of the present invention includes an inwardly extending, semi-circular, flanged portion providing peripheral support for the inwardly extending proximal end portion of the arcuate bracket and for securing the bracket in direct connection with the mounting plate. When called for, the inwardly extending flanged portion may be of dimension permitting spot welding or brazing securement of the proximal end of the bracket.

The mounting plate of this invention has been improved to provide facile installation procedure to allow a plumber or other installer, ease in insertion of the bracket unit at any position along the tubing line and securement in several mounting positions relative to a supporting rail or pair of rails adapted to extend across the open area of the space defined by parallel stationary support members, such as partioning wall studs or horizontal, closely positioned, floor joists.

In particular, and as disclosed and claimed in the aforementioned '224 patent, the arcuate channel of the bracket member preferably includes oppositely positioned sidewalls for sidewise support of the flexible conduit. The sidewalls and channel define a proximal end portion, an intermediate portion and a distal end portion for adjustable and removable support of the conduit. The first-mentioned sidewall is preferably tapered at its proximate end towards the mounting bracket to provide a semi-circular formation mating with an inwardly extending, semi-circular, flange, and which may be fastened thereto by means of spot welding or other securement means.

These and other objects and features will become apparent to those skilled in the plumbing installation and other conduit installation arts upon reading the following description, and with reference to the accompanying drawings.

### BRIEF DESCRIPTION OF THE DRAWINGS

FIG. 1 is a perspective view of a clamping device including the improved, but unmounted version of the mounting plate of this invention, and having means for supporting a flexible conduit to be adjustably secured to a longitudinally extending rail member.

FIG. 2A is a perspective view of another embodiment of this invention illustrating the mounting plate/bracket assembly in further detail and comprising the improved clamping device of FIG. 1.

FIG. 2B is a right-side view, partially in section, of the second embodiment of the present invention taken along a plane 2B-2B of the embodiment shown in the view of FIG. 2A.

FIG. 2C is a right-side elevational view, similar to the view of FIG. 2B, but further illustrating the embodiment of FIG. 1.

FIG. 3 is a right-side elevational view of the clamping device of FIG. 2B, and including a fragmentary distal portion of a flexible conduit (shown in phantom) supported by the clamping device of FIG. 2B.

FIG. 4 is a left-side elevational view, partially in section, of the integrally stamped and formed embodiment disclosed in the views of FIGS. 2A and 2B.

FIG. 5 is a front elevational view of the embodiment disclosed in FIGS. 2A and 2B.

FIG. 6 is a rear elevational view of the embodiment disclosed in FIGS. 2A, 2B, and 5.

FIG. 7 is a top plan view of the embodiment of FIGS. 2A and 2B.

FIG. 8 is a bottom plan view of the embodiment disclosed in FIGS. 2A and 2B.

FIG. 9 is a perspective view of an installation of the improved clamping devices of this invention, and further illustrating the improved mounting plates being supported by a single rail member having a latching finger embodiment of FIGS. 2A and 2B, and extending between two stationary support members, such as upright parallel studs customarily supplied for support and definition of defining wallboards.

FIGS. 10A and 10B are each illustrative of typical installations of the stationary mounting plate of the embodiments shown, in particular, in the view of FIG. 4.

The view of FIGS. 9 and 10A, for instance, show the improved mounting plate mounted on a single rail member, which rail member extends across the space defined by parallel, oppositely disposed, supporting wall stud members, and whereas the views of FIGS. 10B and 11 illustrate the plate being further secured by means of a pair of parallel, spaced-apart, rail members 25, 26 where an installation so requires.

FIG. 11 additionally illustrates the front side of a double rail support version of the mounting support plate of the present invention utilizing the addition of a conventional fastener, such as screw or bolt extending through the exposed mounting plate surface and through the additional surface of the added supporting rail where added strength is desired or required.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiments have been described, the details may be changed without departing from the invention, which is defined by the claims.

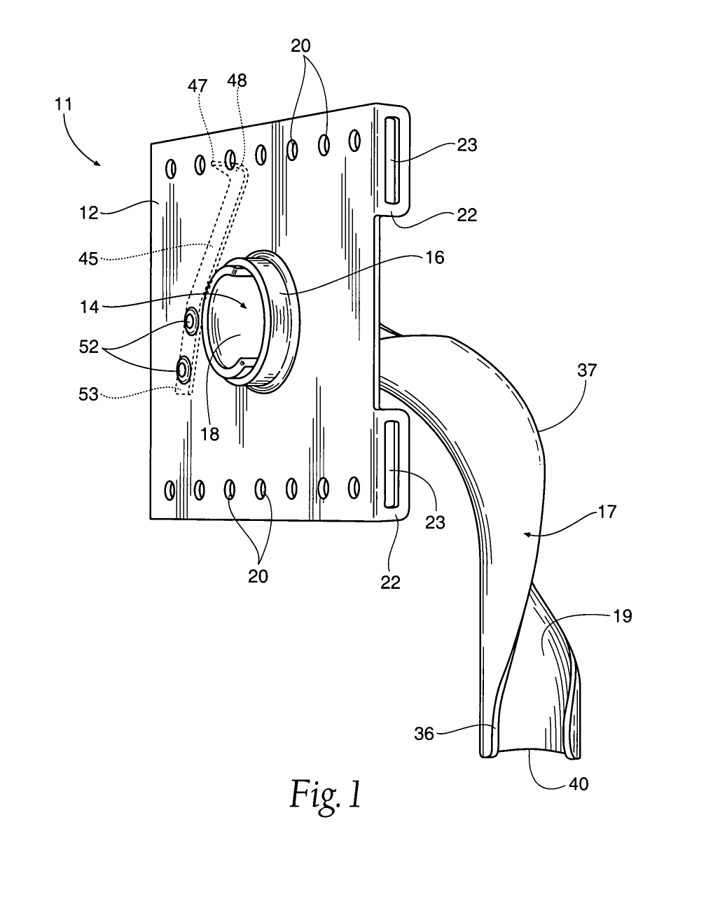

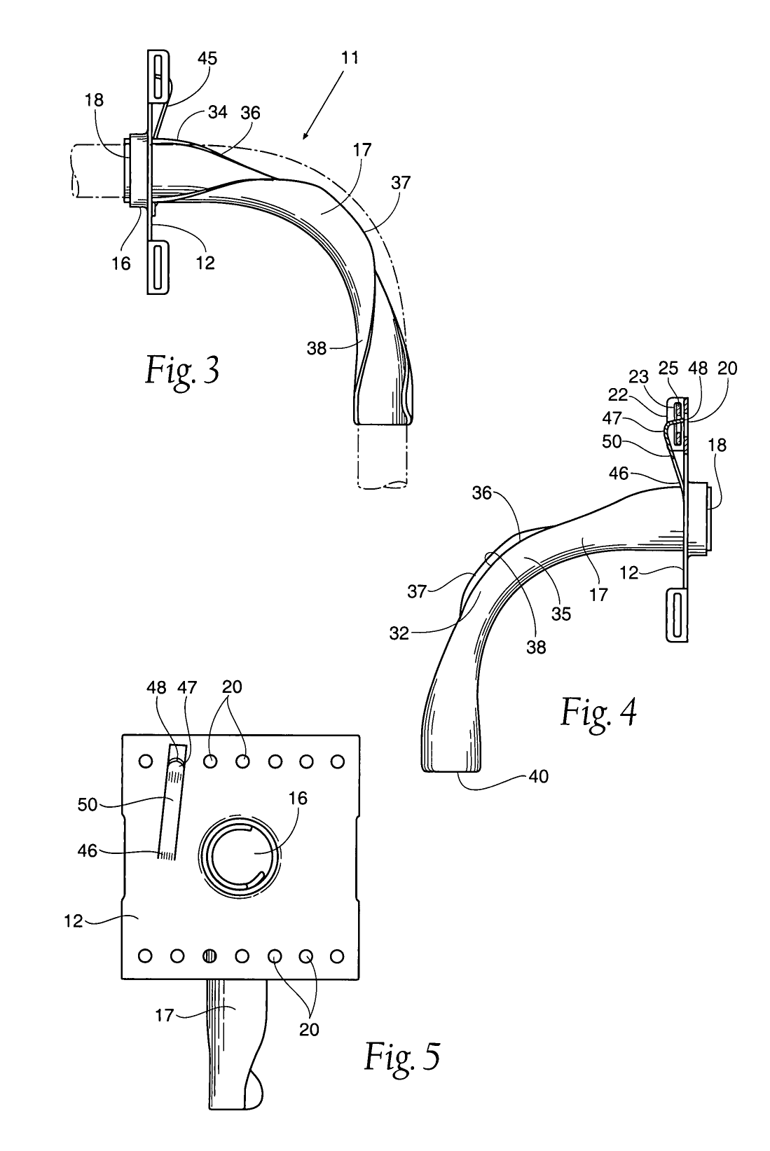

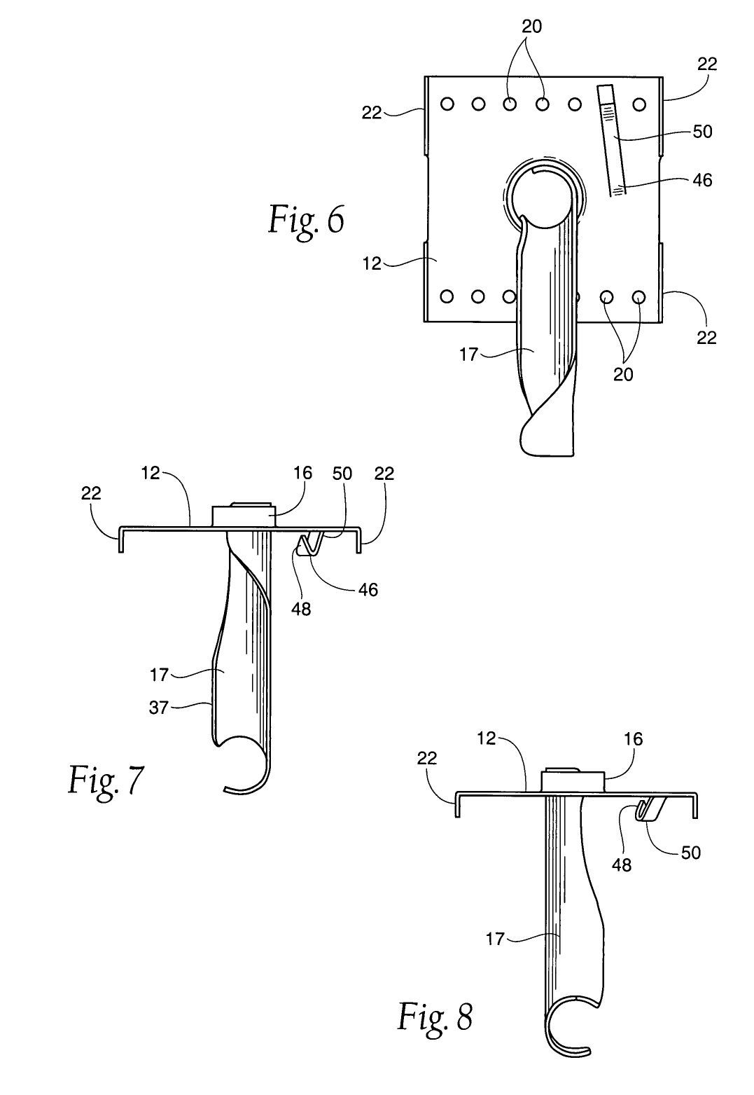

FIGS. 1 through 11, inclusive, illustrate preferred embodiments of the present invention as applied to a flexible tubular conduit of PEX cross-linked polyethylene material (shown in phantom in FIG. 3).

In the various drawing figures, it will be noted that the clamping device, denoted generally by the reference numeral 11, includes the mounting plate 12 which may be stamped from a sheet-like metallic material, or vacuum-formed from a plastic molding material, or otherwise fabricated to include a circular opening 14 defined by an inwardly extending annular flange 16 surrounding the circular opening 14, as shown. The flange 16 may be formed by conventional fabrication techniques, including use of punching, drawing or spinning tools and fixtures.

The circular flange 16 is arranged to secure the supporting bracket 17 to the mounting plate 12 by means of spot welding, brazing or simple clamping, where feasible. It is also within the province of this invention to supply a mounting plate 12 made of a vacuum-formed, or other plastic forming techniques used in fabricating flat, sheet-like objects. In such case, plate 12 and the supporting bracket 17 may be joined together by means of conventional adhesive bonding or similar securing means for attaching adjoining plastic or resinous members.

Although it is preferred to use metallic stampings to provide the clamping device 11, it is within the province of this invention to utilize molded members of resinous plastic materials.

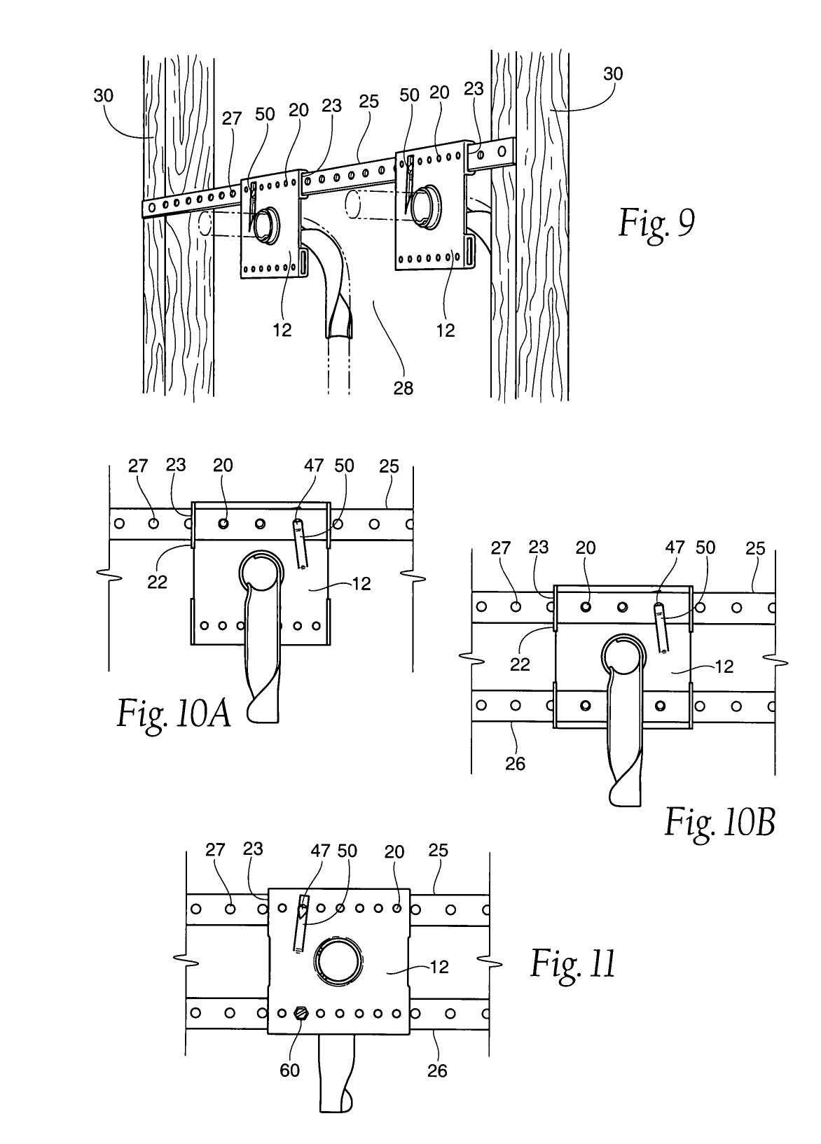

The mounting plate 12 further includes a plurality of openings or apertures 20 for mounting the plate 12 and supporting bracket 17 to a stationary support structure, such as the laterally spaced, vertical wall studs 24 (see FIG. 9).

As shown in detail in the views of FIGS. 1, 2A, 2B, 3, 4, 6-9, 10A, 10B, and 11, the improved mounting plate 12 may be further stamped and bent to provide laterally spaced, upstanding ear portions 22. The ear portions 22 are each preferably provided with elongated apertures or slots 23 for slidably receiving a rail member 25 (see FIGS. 9-11, inclusive) and in particular, where further support is required, a pair of rail members 25 and 26 (see FIGS. 10B and 11). The rail members 25 and/or 26 are preferably stamped from flat stock and thereafter being seated within the respective slots 23 of the ears 22 of the respective versions of the mounting plate 12. The rail members 25 and/or 26 are commercially known as HICO bars and come in predetermined lengths such as 18, 26 and 28 inches. Each rail member 25 and 26 typically has a series of uniform openings or apertures 27 formed along it length. Preferably, respective plate apertures 20 and rail apertures 27 may be aligned for positioning the mounting plate 12 longitudinally relative to both rails 25 and 26 for additional stability.

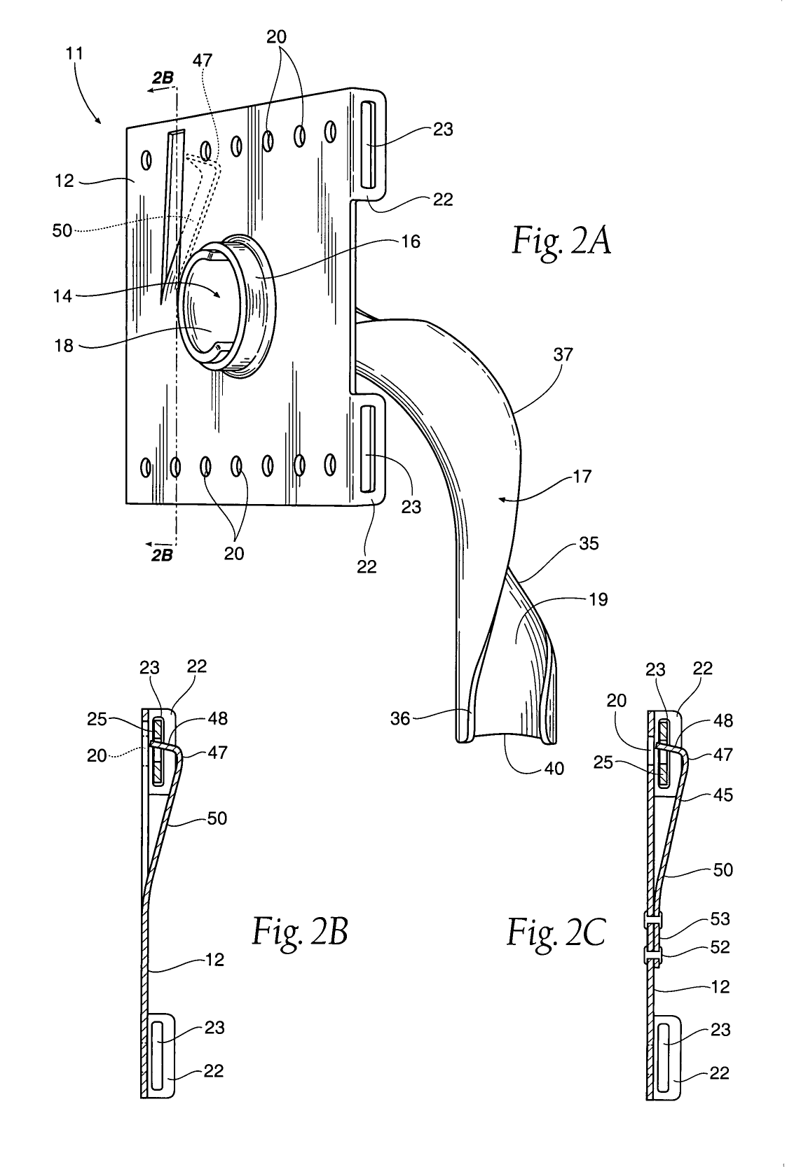

As stated previously, the supporting bracket 17 is preferably formed from a sheet metal stamping to provide a continuous arcuate channel 19 having a proximal end 18 seated in the opening 14 of the plate 12 supported by and secured therein by means of the inwardly extending flange 16. The surrounding flange 16 may be crimped around the bracket 17, and if necessary, it may be spot welded or brazed to the proximal end 18 of the bracket 17. The channel 19 includes oppositely disposed sidewalls 35 and 36. As will be apparent from FIGS. 1 and 2A, the sidewall 35 includes a crested intermediate portion 37 which extends above the margin 38 defining the sidewall 35 and tapers downwardly at both proximal end portion 18 and its distal end portion 40.

With particular regard to the views of FIGS. 1 and 2A, it will be observed that an operating embodiment of the improved mounting plate 12 includes the feature or features of a simplified locking or latching means, in the form of the latching finger 45/50 for retaining the desired relative lateral position between the adjoining supporting rail 25 and/or rail 26 and the mounting plate 12. The resilient latching finger 50 may be pierced or lanced and integrally formed or bumped to be laterally extending from the underside of the plate 12, as shown in the embodiments of FIGS. 2A, 2B and 5. Thus, the leaf-like remaining free end portion of the biasing latching finger 45 may be stamped and formed to have its proximal end 46 being an integrally formed portion of the mounting plate 12 (see FIG. 5). As illustrated in the embodiment of FIGS. 1 and 2C, the latching finger 45 may be formed as a separate and independent member riveted (see rivets 52) or otherwise secured at its proximate end 53 by spot welding or other known securing technique. The distal end portion 46 is formed by known forming techniques and fixturing and tooling to be free from the surface of the mounting plate 12. The distal end portion 47 the latching finger 45 is further bent, or otherwise formed, to be initially spaced from the inner surface of the plate 12 for freedom of movement during installation and positioning of the plate 12 with respect to the selected aperture 20 of the plate 12 and mating with the registering coaxial aperture 27, in either or both of the selected rail members 25 or 26. Thus, the distal end portion 47 of the latching finger 45, as shown in FIG. 2B, may be upended to further define a tapered tine portion 48 adapted to be biased towards insertion within the selected aperture 30 of the rail 25 or 26 when used. The tine portion 48 preferably extends through the aperture 30 of the respective rail members 25, 26 to the corresponding coaxial aperture 20 of the mounting plate 12, thereby latching or locking the plate 12 to the respective rail 25.

Another embodiment of the present invention may be provided where relatively sophisticated fabrication techniques are available. The latching embodiment of FIGS. 2A, 2B, 4-11, inclusive, provide for an integrally formed leaf-like latching finger 50. The embodiment of FIGS. 1 and 2B include an independently formed latching finger 45 stamped and formed from a flat sheet similar material thickness to that of the plate 20. The latching finger 45 is mounted at its proximate end 53 to the plate 12 by means of conventional rivets 52.

It will also be apparent from the view of FIG. 11, that separate latching means may be provided by a self-tapping threaded screw 60 extending through the selected coaxial openings 20 and 30 respectively located in plate 12 and rail 25, 26. A combined nut and bolt fastener 60 (not shown) may also be substituted for the screw 60.

Multiple plates 12 can be mounted on a single rail 25. For example and as shown in FIG. 9, two plates could be used in an application calling for both hot and cold water supplies. In addition, it is contemplated that more than two plates 12 could be mounted on a single rail 25 as well.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A mount for attaching a flexible conduit to a supporting structure, and wherein said supporting structure contains a laterally extending supporting rail, and further wherein said mount comprises:
a mounting plate surface including at least one pair of spaced apart, upstanding, ear portions extending from said mounting plate surface;
each of said mounting plate ear portions respectively containing a rail supporting aperture positioned in relative coaxial alignment;
each ear portion respectively arranged to slidably receive said rail; and
wherein said mounting plate and said rail each include adjacent, mating surfaces containing at least one aperture respectively positioned for relative registerable, coaxial alignment of respective rail and mounting plate apertures.

2. The mount of claim 1 further comprising a latching means including a latching finger having a proximal end portion attached to said mounting surface and extending outwardly from said mounting plate surface to provide a latching distal end portion, said distal end portion being biased towards said at least one of said registerable apertures in said mounting plate and said rail for restraining relative movement of said mounting plate and said rail.

3. The mount of claim 1 wherein said mounting plate contains a bracket supporting aperture defined by a surrounding, laterally extending, continuous flange; and
wherein a bracket is formed from a sheet-like material and includes a continuous arcuate channel configured with its proximal end portion being adapted for receipt by and securement to the continuous flange bracket supporting aperture in said mounting plate.

4. The mount of claim 3 wherein said bracket extends laterally outwardly from said mounting plate;
said bracket being formed from a sheet-like material and including an elongate, continuous, arcuate channel for supporting said flexible conduit; and
said channel including oppositely disposed first and second substantially coextensive sidewalls for sidewise support of said conduit.
said bracket member and bracket member channel including a proximal end portion, an intermediate portion and a distal end portion,
said first sidewall having an outer marginal edge configured to follow the arcuate contour of said channel, the second sidewall having an undulating marginal contour defining an intermediate crested area extending above the marginal edge of said first sidewall to provide additional sidewise support of said flexible conduit, the proximal end portion of said bracket member being tapered towards and crimpingly secured to the inwardly flanged opening in said mounting plate, and
the distal end portion of said channel having its first sidewall being further formed to laterally extend from said channel to form a reverse bend contoured inwardly to provide a partial enclosure for grasping and retaining said conduit and thereby minimize advantageous movement of said flexible conduit with respect to said bracket.

5. The mount of claim 1 further comprising a latching finger wherein the distal end portion of said finger includes an inwardly bent tine portion having an apex extendable within a selected one of said registerable apertures in said rail for restraining relative movement of said mounting plate and said rail member.

6. The mount of claim 1 wherein a latching finger is formed integrally relative to said mounting plate and has a proximal end portion in secured relationship with said mounting plate surface, and with an intermediate portion and a distal portion extending angularly outwardly with respect to said surface, said distal end portion being further bent inwardly towards said surface and having a pointed end with its apex being arranged to extend inwardly relative to said at least one aperture of said mounting plate.

7. The mount of claim 1, wherein a latching finger is stamped and formed from sheet-like material to include a proximal end portion, an intermediate portion and a distal end portion, said proximal end portion being in facing relationship with said mounting plate surface, and fastening means for securing said finger to said mounting plate surface with the intermediate portion and a distal portion extending angularly outwardly with respect to said surface, said distal end portion being further bent inwardly towards said surface and having a pointed end with its apex being arranged to extend inwardly relative to said at least one aperture of said mounting plate.

8. The mount of claim 1 wherein said mounting plate is metallic and is stamped, pierced and formed from sheet metal.
